(19) United States
(12) Patent Application Publication
(10) Pub. No.: US 2026/0252359 A1
(43) Pub. Date: Aug. 27, 2026

(54) MANAGING STARTUP OF A DATA PROCESSING SYSTEM USING LOGS OF TRUST STORES

(71) Applicant: Dell Products L.P., Round Rock, TX (US)

(72) Inventors: NICHOLAS D. GROBELNY, Evergreen, CO (US); AMY CHRISTINE NELSON, Round Rock, TX (US); DAVID ALBERT CONSOLVER, Hurst, TX (US); RAMAN SHARMA, Leander, TX (US); RICHARD M. TONRY, Georgetown, TX (US)

(21) Appl. No.: 19/062,617

(22) Filed: Feb. 25, 2025

(51) Int. Cl. G06F 9/4401

(52) U.S. Cl. CPC G06F 9/4401

(57) ABSTRACT

Methods and systems for managing operation of a data processing system are disclosed. To manage operation of the data processing system, an occurrence of a security event may be identified by an entity of the data processing system. The entity may obtain a copy of a local certificate trust store log, the local certificate trust store log indicating modifications made to a local certificate trust store managed by the data processing system. The entity and a remote system may cooperatively identify a security state of the data processing system based on the copy of the local certificate trust store log. Operation of the data processing system may be managed based on the security state to reduce a likelihood of the data processing system being compromised.

### FIELD

Embodiments disclosed herein relate generally to managing operation of a data processing system. More particularly, embodiments disclosed herein relate to systems and methods to manage startup of a data processing system using logs of trust stores.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2D show diagrams illustrating data flows in accordance with an embodiment.

FIG. 3 shows a flow diagram illustrating a method for managing operation of a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may include hardware and/or software components that, in some combination, may be used to provide computer-implemented services. To provide the computer-implemented services, the data processing system may undergo a startup during which functionality of a portion of its hardware and/or software components may be enabled.

For example, during a secure boot (e.g., a type of startup) of the data processing system, the tasks may include security checks where integrity of portions of the startup data are validated (e.g., secure boot verification). The secure boot verification may be performed (e.g., using reference values data stored by the data processing system, using a security manager of the data processing system such as a trusted platform module (TPM)) in order to establish trust in each portion of the startup data before use (e.g., execution), so that exposure to malicious or erroneous software is unlikely. Doing so may reduce a risk of compromise of the data processing system, errors occurring during startup, etc.

To perform the tasks associated with the startup, the startup manager may communicate with the hardware components (e.g., devices) using a predefined industry standard, such as a security protocol and data model (e.g., SPDM) security standard. For example, the startup manager may use the SPDM security standard to obtain a certificate (e.g., at least a portion of a certificate chain and/or a digest of the at least the portion of the certificate chain) from a device during startup. The certificate may be used to perform a certificate analysis process to establish an acceptable level of trust that the device will not compromise the data processing system once booted. During the certificate analysis process, a signature verification process may be performed to establish trust in each portion of a certificate chain (e.g., the certificate chain may be cryptographically validated). Performing the certificate analysis process may also include verifying that a root certificate of the certificate chain is trusted by the data processing system.

To verify that the root certificate of the certificate chain is trusted by the data processing system, a local certificate trust store may be used. The local certificate trust store may be managed by the data processing system, and may include root certificates (and/or other types of certificates) and levels of trust for the root certificates indicating whether each root certificate is trusted or untrusted. By verifying the trustworthiness of the root certificate, trust may be established in the certificate chain linked to the root certificate. Doing so may allow the device to be verified as trustworthy and may allow booting of the device to proceed.

Over time, modifications to the local certificate trust store may be made. For example, root certificates stored in the local certificate trust store may be added, replaced (e.g., due to expiration), removed, and/or otherwise modified. However, if the local certificate trust store is modified by an unauthorized (e.g., malicious) entity, the data processing system may become compromised. For example, if an unauthorized entity adds a root certificate to the local certificate trust store, malicious devices may be allowed to boot by the data processing system. As a result, the quality and/or availability of computer-implemented services provided by the data processing system may be negatively impacted.

To reduce a likelihood of the data processing system becoming compromised, an entity of the data processing system (e.g., an operating system agent) may identify an occurrence of a security event. The entity may obtain a copy of a local certificate trust store log for the local certificate trust store, which may indicate modifications made to the local certificate trust store. Based on the copy of the local certificate trust store log, a security state of the data processing system may be cooperatively identified by the entity and a remote system (e.g., a server, any other type of remote system that participates in managing the security of the data processing system). Based on the security state, operation of the data processing system may be managed.

To cooperatively identify the security state of the data processing system, the entity may provide the copy of the local certificate trust store log to the remote system. The entity may then obtain, from the remote system, the security state. The security state may be based on an outcome of comparing the copy of the local certificate trust store log to a remote certificate trust store log managed by the remote system. The remote certificate trust store log may indicate modifications made to a remote certificate trust store managed by the remote system, and the copy of the local certificate trust store log may be a duplication of the remote certificate trust store log when the data processing system is in a secure security state.

In an embodiment, a method for managing operation of a data processing system is disclosed. The method may include: identifying, by an entity of the data processing system, an occurrence of a security event for the data processing system; obtaining, by the entity, a copy of a local certificate trust store log, the local certificate trust store log indicating modifications made to a local certificate trust store managed by the data processing system; cooperatively identifying, by the entity and a remote system, a security state of the data processing system based on the copy of the local certificate trust store log; and managing operation of the data processing system based on the security state to reduce a likelihood of the data processing system being compromised.

Cooperatively identifying the security state of the data processing system may include: providing, by the entity, the copy of the local certificate trust store log to the remote system; and obtaining, by the entity, the security state of the data processing system from the remote system, the security state of the data processing system being based on an outcome of comparing the copy of the local certificate trust store log to a remote certificate trust store log managed by the remote system.

The remote certificate trust store log may indicate modifications made to a remote certificate trust store managed by the remote system.

The remote system may be a source of truth for the data processing system, and the remote certificate trust store may be trusted by the data processing system to not be compromised by a malicious entity.

The data processing system may be in a secure state when the local certificate trust store log is a duplication of at least a portion of the remote certificate trust store log.

Managing operation of the data processing system may include: identifying, based on the security state of the data processing system and a policy including actions keyed to security states of data processing systems, at least one actions; and initiating performance of the at least one action.

In an instance of the cooperatively identifying in which the data processing system is in a compromised security state, the at least one action to manage operation of the data processing system may include at least one action selected from a list of actions consisting of: notifying a management entity of the data processing system; quarantining at least a portion of devices operably connected to the data processing system; monitoring the at least the portion of devices operably connected to the data processing system for indications of malicious activity; and preventing the data processing system from performing at least a portion of its functionality until the data processing system is in a secure security state.

The local certificate trust store may include certificates and/or digests of certificates usable to determine a level of trust in a security protocol and data model (SPDM) security standard compliant device during a startup of the data processing system.

The level of trust in the SPDM security standard compliant device may be determined by comparing a certificate obtained from the device to the certificates in the local certificate trust store.

The entity of the data processing system may be an operating system agent.

The method may also include: in an instance of the cooperatively identifying in which the data processing system is in a secure security state: during a startup of the data processing system: performing, using a certificate obtained from a device of the data processing system using an SPDM security standard and the local certificate trust store, an analysis process to identify a level of trust in the device; in an instance of the performing in which the level of trust in the device is trusted: performing a measurement process using the SPDM security standard for the device to obtain at least one measurement; and managing operation of the device based on the at least one measurement.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

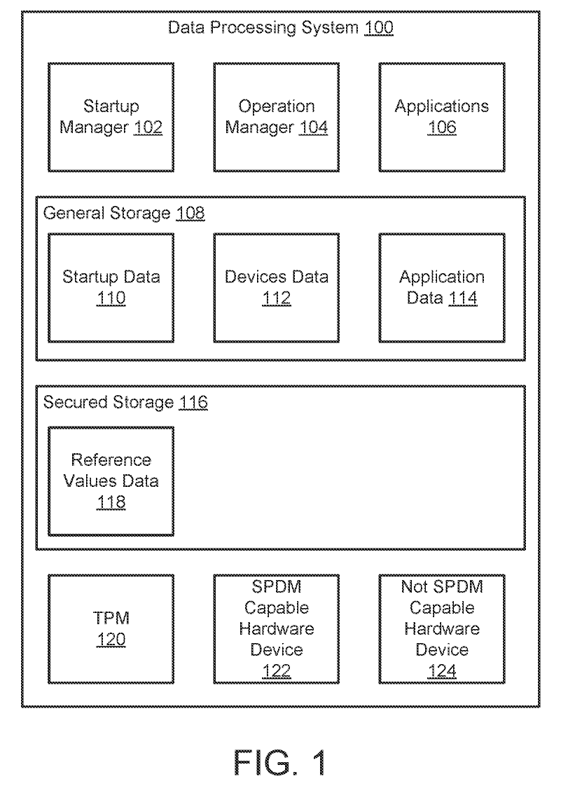

Turning to FIG. 1, a block diagram illustrating a system in accordance with an embodiment is shown. The system shown in FIG. 1 may provide computer-implemented services. The computer-implemented services may include, for example, database services, data processing services, communication services, and/or any other services that may be provided using one or more computing devices. Other types of computer-implemented services may be provided by the system without departing from embodiments disclosed herein.

To provide the computer-implemented services, the system (e.g., a data processing system) may undergo a startup during which functionality of a portion of its hardware and/or software components may be enabled. For example, the computer-implemented services may require access to processors, memory modules, storage devices, communication devices, and/or other devices operably connected to the data processing system. The hardware components (e.g., devices) may support execution of any number and/or type of software components (e.g., applications), and, in some combination, the hardware and software components may provide for various types of computer-implemented services.

To perform the startup, a startup manager of the data processing system (e.g., a basic input/output system (BIOS)) may access, verify, and use data stored by the data processing system and/or retrieved from the hardware components (e.g., startup data). The startup data may include instructions corresponding to software usable to facilitate various tasks of the startup (e.g., tasks for performing device verification and initialization, and/or other tasks related to enabling and/or securing hardware functionality), data structures usable to verify the integrity and/or authenticity of the software hosted by the hardware components (e.g., firmware), and/or data structures usable to establish trust in hardware components (e.g., portions of certificate chains, digests of the portions of certificate chains).

For example, during a secure boot (e.g., a type of startup) of the data processing system, the tasks may include security checks where integrity of portions of the startup data are validated (e.g., secure boot verification). The secure boot verification may be performed (e.g., using reference values data stored by the data processing system, using a security manager of the data processing system such as a trusted platform module (TPM)) in order to establish trust in each portion of the startup data before use (e.g., execution), so that exposure to malicious or erroneous software is unlikely. Doing so may reduce a risk of compromise of the data processing system, errors occurring during startup, etc.

The tasks associated with the startup may be performed by the startup manager in sequence throughout the startup process. By performing the tasks associated with the startup in sequence, the risk of compromise of the data processing system may be further reduced.

To perform the tasks associated with the startup, the startup manager may communicate with the devices using a predefined industry standard, such as a security protocol and data model (e.g., SPDM) security standard. Communicating with the devices using the SPDM security standard may allow the startup manager to retrieve data structures from the devices usable to verify the integrity and/or authenticity of the software hosted by the devices and/or analyze certificate chains for the devices in a manner that establishes an acceptable level of trust that the devices will not compromise the data processing system once booted.

For example, establishing an acceptable level of trust in the devices may include performing a certificate analysis process. During the certificate analysis process, a signature verification process may be performed to establish trust in each portion of a certificate chain (e.g., the certificate chain may be cryptographically validated). Performing the certificate analysis process may also include verifying that a root certificate of the certificate chain is trusted by the data processing system.

To verify that the root certificate of the certificate chain is trusted by the data processing system, a local certificate trust store may be used. The local certificate trust store may be managed by the data processing system, and may include root certificates (and/or other types of certificates, digests of the root certificates) and levels of trust for the root certificates indicating whether each root certificate is trusted or untrusted. By verifying the trustworthiness of the root certificate, trust may be established in the certificate chain linked to the root certificate. Doing so may allow the device to be verified as trustworthy and may allow booting of the device to proceed.

Over time, modifications to the local certificate trust store may be made. For example, root certificates stored in the local certificate trust store may be added, replaced (e.g., due to expiration), removed, and/or otherwise modified. However, if the local certificate trust store is modified by an unauthorized (e.g., malicious) entity, the data processing system may become compromised. For example, if an unauthorized entity adds a root certificate to the local certificate trust store, malicious devices may be allowed to boot by the data processing system. As a result, the quality and/or availability of computer-implemented services provided by the data processing system may be negatively impacted.

In general, embodiments disclosed herein may provide methods, systems, and/or devices for managing startup of a data processing system in a manner that improves security of the data processing system using certificate trust store logs. To do so, an entity of the data processing system (e.g., an operating system agent) may identify an occurrence of a security event. The entity may obtain a copy of a local certificate trust store log for a local certificate trust store managed by the data processing system. The log may indicate modifications made to the local certificate trust store. Based on the copy of the local certificate trust store log, a security state of the data processing system may be cooperatively identified by the entity and a remote system (e.g., a server, any other type of remote system that participates in managing security of the data processing system). Based on the security state, operation of the data processing system may be managed.

To cooperatively identify the security state of the data processing system, the entity may provide the copy of the local certificate trust store log to the remote system. The entity may then obtain, from the remote system, the security state. The security state may be based on an outcome of comparing the copy of the local certificate trust store log to a remote certificate trust store log managed by the remote system. The remote certificate trust store log may indicate modifications made to a remote certificate trust store managed by the remote system, and the copy of the local certificate trust store log may be a duplication (e.g., match) of the remote certificate trust store log when the data processing system is in a secure security state.

By doing so, embodiments disclosed herein may improve security of a data processing system by increasing a likelihood of detecting unauthorized modifications to a local certificate trust store managed by the data processing system. By comparing a copy of a local certificate trust store log to a remote certificate trust store log (e.g., managed by a remote entity), an outcome of the comparing may be used to identify a security state of the data processing system. By identifying and performing at least one action based on the security state and a policy for managing data processing systems based on security states, computer-implemented services may be provided as desired by the data processing system in a manner that maintains the security of the data processing system.

To provide the above noted functionality, the system of FIG. 1 may include data processing system 100, startup manager 102, operation manager 104, applications 106, general storage 108, secured storage 116, trusted platform module (TPM) 120, security protocol and data model (SPDM) capable hardware device 122, and not SPDM capable hardware device 124. Each of these components is discussed below.

Data processing system 100 may include any number of hardware components (e.g., processors, memory modules, storage devices, communications chips, other devices). The hardware components may support execution of any number and/or type of software components (e.g., startup manager 102, operation manager 104, applications 106, etc.).

Data processing system 100 may provide any number and type of computer-implemented services. To provide the computer-implemented services, data processing system 100 may include startup manager 102. Startup manager 102 may include a startup management entity (e.g., a basic input/output system (BIOS)) hosted by a hardware processor of data processing system 100 and may facilitate management of startup of data processing system 100 from power on to booting to operation manager 104. The startup of data processing system 100 may include performing a secure boot procedure. During the secure boot procedure, startup manager 102 may perform tasks related to device verification and initialization, and/or other tasks related to enabling and/or securing hardware functionality.

To perform its functionality, startup manager 102 may: (i) perform device enumeration tasks to obtain a list of devices (e.g., hardware components) operably connected to data processing system 100 which are compliant with a security protocol and data model (SPDM) security standard (e.g., including obtaining identifiers for the devices such as globally unique identifiers (GUIDs)), (ii) collect, using the SPDM security standard, startup data 110 from the devices in the list of devices, startup data 110 including certificates for the devices (e.g., at least a portion of a certificate chain for each device), (iii) obtain, using any type and/or quantity of predetermined functions (e.g., hash functions, other algorithms) digests for the certificates, (iv) perform analysis processes using the certificates and a local certificate trust store (e.g., stored as part of reference values data 118) to determine a level of trust in each device (e.g., trusted, untrusted, and/or indeterminate), and/or (v) perform other tasks.

The devices operably connected to data processing system 100 may be compliant with the SPDM security protocol (e.g., SPDM capable hardware device 122) or may not be compliant with the SPDM security protocol (e.g., not SPDM capable hardware device 124). SPDM capable hardware device 122 may include a device with SPDM capabilities. For example, SPDM capable hardware device 122 may be designed to comply with the SPDM security standard managed by the Distributed Management Task Force (DMTF). Complying with the SPDM security standard may allow the device to have its identity authenticated and its integrity verified in a manner that allows startup manager 102 to have an acceptable level of trust that the device is not compromised and/or malicious. Not SPDM capable hardware device 124 may be unable to have its identity authenticated and/or its integrity verified in the manner that allows startup manager 102 to have the acceptable level of trust. Thus, not SPDM capable hardware device 124 may be prevented from booting and/or may have a portion of its functionality restricted during operation of data processing system 100 (or at least until subsequent verification procedures are performed).

While described with respect to determining whether a device is compliant with the SPDM security protocol managed by the DMTF, it will be appreciated that device compliance with any other security standard may be determined in a similar manner without departing from embodiments disclosed herein.

Devices data 112 may include an existing list (and/or may be implemented using, for example, tables, unstructured data, trees, databases, etc.) for which startup manager 102 and/or any other entity has previously obtained information regarding SPDM capabilities. For example, devices data 112 may include an identifier for a device, and an indication corresponding to the identifier regarding whether the device is compliant with the SPDM security standard.

Devices data 112 may be stored in general storage 108 and may be used by startup manager 102 to determine whether any of the devices are new devices. For example, startup manager 102 may obtain an identifier for a graphics processing unit (GPU) during device enumeration. Startup manager 102 may perform a lookup process in a table of devices and corresponding SPDM capabilities included in devices data 112 using the identifier as a key for the lookup process. If startup manager 102 determines that the GPU is a new device (e.g., no entries in the table of devices correspond to the identifier), startup manager 102 may proceed to obtain the SPDM capabilities of the GPU.

The SPDM capabilities for a new device may be obtained by checking the firmware and/or system documentation of the new device to determine whether the new device supports the SPDM security standard. A dedicated tool and/or command may be used to query the new device for its specific SPDM capabilities, including supported cryptographic algorithms and/or certificate formats (e.g., via an SPDM message exchange with the new device to retrieve its identity certificate and/or associated details about its security features). Any information obtained from the new device while obtaining the SPDM capabilities of the new device may be added to devices data 112 and used during subsequent startups of data processing system 100.

For the SPDM security standard compliant devices (e.g., SPDM capable hardware device 122), startup manager 102 may obtain startup data 110 from the devices following the SPDM security standard. Startup data 110 may include data structures obtained from the devices that are usable to identify an acceptable manner of managing operation of the devices by startup manager 102 (e.g., using identification data such as device certificates, root certificates, certificate chains, digests of the device certificates, root certificates, and/or certificate chains). For example, the data structures obtained from the devices as part of startup data 110 may be usable to determine levels of trust in the devices. Operation of the data processing system and/or devices may be managed based on the levels of trust (e.g., based on a policy and/or other rule set for managing devices).

Startup data 110 may also include measurements obtained from SPDM security standard compliant devices. The measurements may be usable to verify the integrity and/or authenticity of the software hosted by the devices. The measurements may be obtained for all and/or a portion of the SPDM security standard compliant devices. For example, the measurements may be obtained from devices determined by startup manager 102 to have a trusted level of trust (e.g., based on an outcome of comparing certificates for the devices to certificates included in the local certificate trust store, and/or may be obtained for any devices for which a policy indicates a measurement process is to be performed). The measurements may include cryptographic hashes, digital fingerprints, and/or other data structures that indicate the current state of a device's firmware, configuration, and/or other characteristics of the components. Startup manager 102 may perform the measurement process and may provide the measurements to trusted platform module (TPM) 120 to perform verification processes to verify the integrity and/or authenticity of the devices (e.g., using reference values data 118). Based on an outcome of the verification processes (e.g., a report generated by TPM 120), startup manager 102 may boot to operation manager 104, restrict capabilities of operation manager 104, and/or prevent booting to operation manager 104.

TPM 120 may be a hardware component that is distinguishable from the hardware processor that hosts startup manager 102 and may provide security management services for data processing system 100 (e.g., may comply with ISO/IEC 11889:2009, any of the TPM Library specification such as Version 2.0, and/or may conform operation to other industry standards). To provide the security management services, TPM 120 may (e.g., in collaboration with startup manager 102): (i) facilitate verification of startup data 110 using reference values data 118 to establish trust in each portion of startup data 110 before use (e.g., execution), so that exposure to malicious or erroneous software is unlikely (e.g., is not executed), (ii) store and restrict use of secrets (e.g., public/private keys, etc.) based on security posture of data processing system 100, and (iii) facilitate the identification of (e.g., in collaboration with software components of the data processing system such as startup manager 102) the security posture of data processing system 100 based on measurements of various components (e.g., firmware hosted by various devices (e.g., 122, 124), software loaded into data processing system 100, hardware/software component presence/absence, etc.) of data processing system 100. Reference values data 118 may include secure boot data usable to verify the integrity and trust in startup data 110 (e.g., various portions of startup data 110) prior to use of (the various portions of) startup data 110. For example, reference values data 118 may include hashes and/or other types of information usable to cryptographically verify trust and integrity of startup data 110. TPM 120 may include data (e.g., a hash, a signature, etc.) usable to verify integrity of reference values data 118.

Reference values data 118 may also include the local certificate trust store, which may include certificates (e.g., portions of certificate chains, digests of the portions of the certificate chains) usable to establish trust in the devices. The local certificate trust store may: (i) be maintained and/or otherwise managed by an operating system agent (e.g., operation manager 104), and (ii) be populated based on a remote certificate trust store (e.g., managed by a remote system). For example, the local certificate trust store may include: (i) root certificates and/or digests of root certificates, levels of trust for the root certificates (e.g., trusted, untrusted), and/or public keys usable to perform signature verification processes, (ii) device certificates (e.g., leaf certificates), digests of device certificates, public keys usable to perform signature verification processes, levels of trust for the device certificates (e.g., trusted, untrusted), and/or (iii) other information trusted by the data processing system and usable to establish trust in devices.

Reference values data 118 may include a local certificate trust store log. The local certificate trust store log may include a log of modifications made to the local certificate trust store. For example, the log may include entries indicating dates, times, details regarding the modifications made to the local certificate trust store, and/or other information. Reference values data 118 may also include a policy usable to determine actions for managing data processing system 100 based on security states of data processing system 100 identified based on the local certificate trust store log.

Reference values data 118 may be stored in secured storage 116. Secured storage 116 may include a hardware storage device for storing data. For example, secured storage 116 may be implemented with a solid state storage device operably connected via a serial peripheral interface (SPI) bus to a processor of data processing system 100. Access to secured storage 116 may be restricted to certain entities and/or for certain uses. For example, secured storage 116 may only be accessible by startup manager 102 for performing tasks during and/or related to startup. The contents of secured storage 116 may be generally inaccessible without providing various credentials such as passwords.

Once the device measurements have been provided to TPM 120 (e.g., and presuming data processing system 100 has been determined to be in a predetermined state using, at least in part, TPM 120), startup manager 102 may hand off management of the operation of data processing system 100 to operation manager 104. Operation manager 104 may include, for example, an operating system, drivers, and/or other entities through which applications 106 may provide all, or a portion of, their functionality. Operation manager 104 may be booted to using startup data 110. Thus, if startup data 110 includes malicious code, undesired code, unauthorized code, etc., then operation manager 104 may operate in a manner that diverges from a desired manner. To reduce this possibility, as discussed above, startup manager 102 may perform various actions to improve a likelihood that data processing system 100 operates in a predetermined (e.g., desired) manner.

Applications 106 may include any type and quantity of applications (e.g., software components) that may provide any type and quantity of computer-implemented services. To do so, applications 106 may generate, store, modify, read, and/or otherwise use application data 114 stored in general storage 108.

General storage 108 may be implemented using physical devices that provide data storage services (e.g., storing data and providing copies of previously stored data). The devices that provide data storage services may include hardware devices and/or logical devices. For example, general storage 108 may include any quantity and/or combination of memory devices (e.g., volatile storage), long term storage devices (e.g., persistent storage), other types of hardware devices that may provide short term and/or long term data storage services, and/or logical storage devices (e.g., virtual persistent storage/virtual volatile storage). General storage 108 may be accessible. For example, operation manager 104 may manage and provide access to data stored in general storage 108.

When providing their functionalities, applications 106 may utilize the functionality of operation manager 104 (e.g., to access computing resources such as processor cycles, transitory storage space, etc.). Thus, if operation manager 104 does not operate in the predetermined manner, then applications 106 may also operate in a manner that diverges from a desired and/or expected manner. The divergence of applications 106 and/or operation manager 104 may cause data processing system 100 to not provide (or provide in a compromised manner) all, or a portion, of the computer-implemented services that are to be provided by data processing system 100.

As part of performing its functionality, operation manager 104 may: (i) obtain updates for the local certificate trust store from a remote system, (ii) manage the local certificate trust store (e.g., initiate updating and/or otherwise modifying the local certificate trust store based on data and/or instructions obtained from the remote system), (iii) identify security events for data processing system 100, (iv) obtain copies of the local certificate trust store log, (v) provide the copies of the local certificate trust store log to the remote system, (vi) obtain actions, identify actions, and/or initiate performance of actions to manage operation of data processing system 100, and/or (vii) perform other tasks.

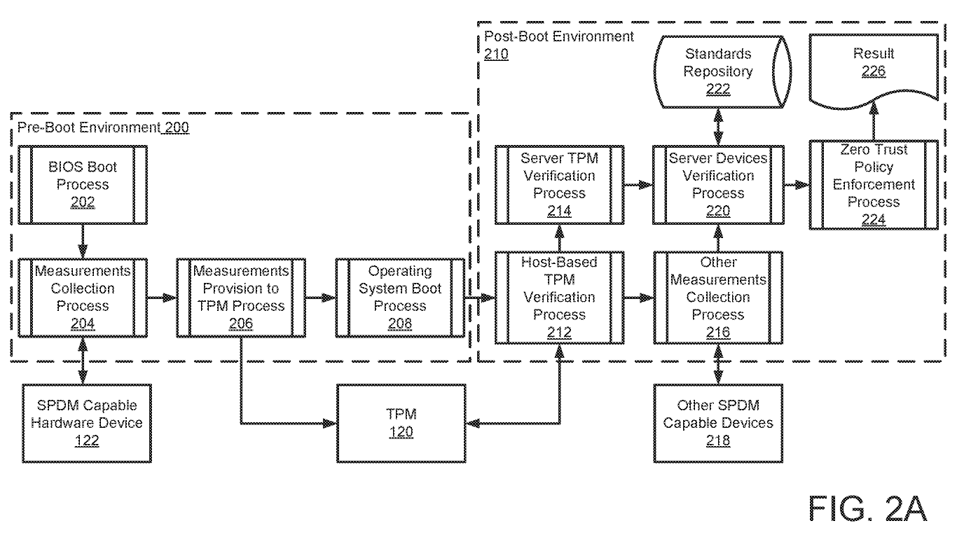

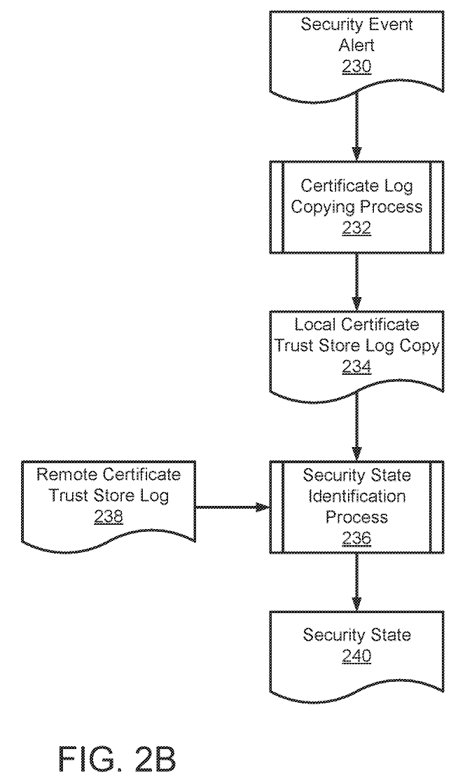

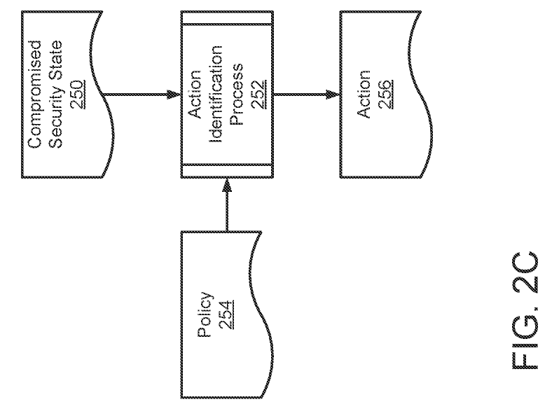

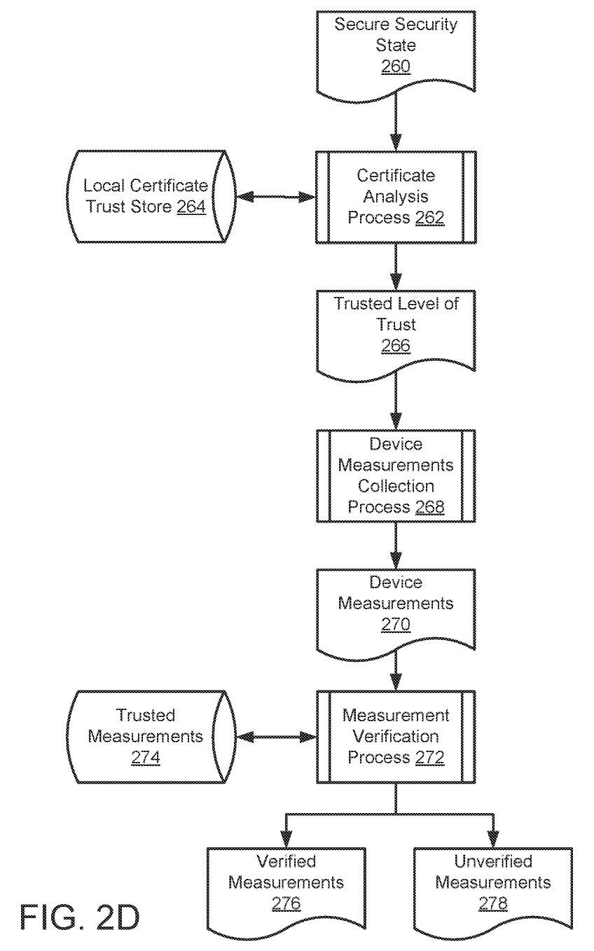

To facilitate provision of the computer-implemented services, data processing system 100 may communicate with the remote system. The remote system may include any number and/or type of devices (e.g., data processing systems, servers) used to manage certificate trust stores of data processing systems. To manage the local certificate trust store hosted by data processing system 100, the remote system may: (i) manage a remote certificate trust store (e.g., modify, update, store, and/or otherwise mange the remote certificate trust store), (ii) manage a remote certificate trust store log (e.g., including entries indicating any modifications made to the remote certificate trust store), (iii) obtain copies of the local certificate trust store log from data processing system 100, (iv) compare the copies of the local certificate trust store log to the remote certificate trust store log to identify security states of data processing system 100, (v) identify actions (e.g., based on a policy) to manage operation of data processing system 100 based on the security states, (vi) provide information regarding the security state and/or identified actions to data processing system 100 (e.g., instructions for performing the actions, the identified security state), and/or (vii) perform other tasks to facilitate provision of the computer-implemented services. Refer to the description of FIG. 2B for additional details regarding identifying security states of data processing systems.

The remote system may be implemented with multiple computing devices. The computing devices of the remote system may cooperatively perform processes for managing the certificate trust stores for any number of data processing systems. The computing devices of the remote system may perform similar and/or different functions, and may be used by different persons (e.g., users) that may participate in the management of the certificate trust stores.

While described with respect to cooperatively identifying security states of data processing system 100 by an entity of data processing system 100 (e.g., operation manager 104) and the remote system, it will be appreciated that other methods and/or devices may be used to identify the security states without departing from embodiments disclosed herein. For example, the security states may be identified using distributed software, centralized software, and/or any devices not shown in FIG. 1. For example, the entity of the data processing system may obtain a copy of the remote certificate trust store log from the remote system, and may use software hosted by the data processing system to compare the copy of the remote certificate trust store log to the local certificate trust store log to identify the security state.

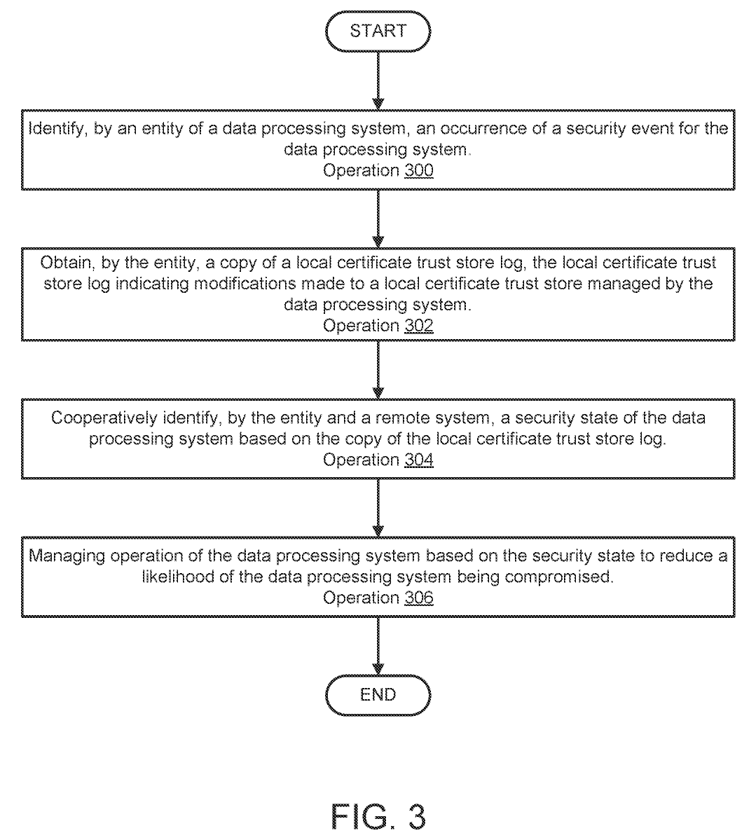

When providing their functionality, any components of data processing system 100 may perform all, or a portion, of the actions and methods illustrated in FIGS. 2A-3.

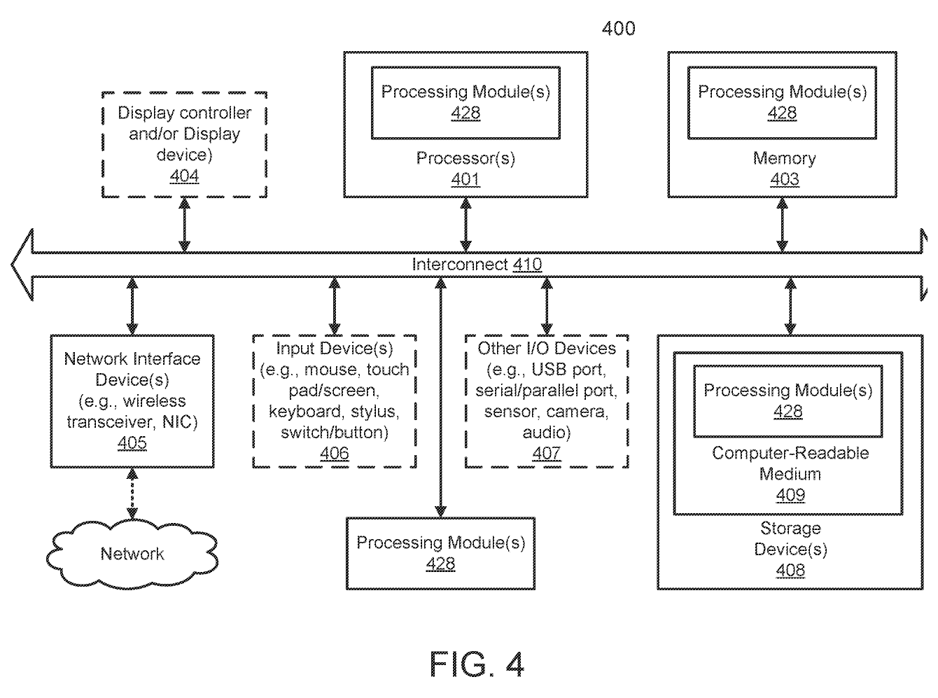

Data processing system 100 (and/or components thereof) may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2D. In these diagrams, flows of data and processing of data are illustrated using different sets of shapes. A first set of shapes (e.g., 226, 230, etc.) is used to represent data structures, a second set of shapes (e.g., 202, 204, etc.) is used to represent processes performed using and/or that generate data, a third set of shapes (e.g., 222, 264, etc.) is used to represent large scale data structures such as databases, and a fourth set of shapes (e.g., 122, 120, etc.) is used to represent hardware components (e.g., also referred to as devices).

Turning to FIG. 2A, a first data flow diagram in accordance with an embodiment is shown. The first data flow diagram may illustrate data used in and data processing performed in managing operation of a data processing system (e.g., similar to data processing system 100 shown in FIG. 1) in a manner that improves a likelihood that the data processing system operates as desired.

To manage operation of the data processing system, generally, a startup process may be performed. The startup process may cause the environment of the data processing system to evolve over time from a pre-boot environment (e.g., 200) to a post-boot environment (e.g., 210) where the data processing system may be in condition to provide desired computer-implemented services. Generally, pre-boot environment 200 refers to the state of the data processing system prior to handing off management to a general management entity, and post-boot environment 210 refers to the state of the data processing system after handing off management to the general management entity (e.g., an operating system). During the startup, various processes may be performed, as will be discussed below, to place the data processing system into a desired security posture where it is less susceptible to malicious attacks.

To begin the startup, basic input/output system (BIOS) boot process 202 (or other types of boot processes, such as to unified extensible firmware based entities, it should be appreciated that BIOS boot process 202 refers to any such processes) may be performed. BIOS boot process 202 may be initiated by powering on the data processing system or resetting the system. During BIOS boot process 202, the BIOS program code may be loaded by a processor (e.g., via a serial peripheral interface (SPI) bus and from a protected storage such as secured storage 116). The BIOS may perform tasks related to startup management for the data processing system during pre-boot environment 200 (e.g., similar to startup manager 102 shown in FIG. 1). For example, the BIOS may perform a secure boot procedure to check program code (e.g., firmware) of various hardware and/or software components (e.g., drivers) in a predefined sequence. Pre-boot environment 200 may include operations performed (e.g., by the BIOS) to hand off management of the data processing system to an operation manager (e.g., an operating system) of the data processing system.

Once the BIOS has been booted, measurements collection process 204 may be performed. During measurements collection process 204, security data may be collected from the hardware and/or software components of the data processing system. The security data may include identification data such as device certificates and/or certificate chains, and/or measurements (e.g., refer to the description of startup data 110 shown in FIG. 1). The security data may be usable to identify an acceptable manner of managing operation of the hardware components by the BIOS and/or verify the authenticity and/or integrity of software hosted by the hardware components using trusted data structures. The identification data obtained as part of the security data may include cryptographically verifiable certificates and/or digests of the certificates. The measurements obtained as part of the security data may include data structures including cryptographic hashes or digital fingerprints that represent the current state of a device's firmware, configuration, drivers, management entity code, and/or other components that may be modified in undesired manners.

For example, the BIOS may perform measurements collection process 204 based on a security protocol and data model (SPDM) security standard. The SPDM security standard may be a data model for hardware components/devices of data processing systems, which may specify, at least: (i) methods of security communication between the hardware components, (ii) minimum standards of data to be made available to other hardware components, (iii) security information to be made available to the other hardware components, and/or (iv) other information. When performing measurements collection process 204, a list of hardware components of the data processing system that are compliant with the SPDM security standard may be obtained. The list of hardware components may be obtained using: (i) an existing list of hardware components that are compliant with the SPDM security standard, and (ii) any new hardware components of the data processing system that are not identified in the existing list.

To collect the measurements from the hardware components, the hardware components may be required to be compliant with the SPDM security standard (e.g., SPDM capable hardware device 122). Compliance with the SPDM security standard may allow the measurements to be collected in a format, using communication protocols, and/or including information specified by the SPDM security standard (e.g., managed by the Distributed Management Task Force (DMTF)). The measurements may be usable to establish an acceptable level of trust that the hardware components will not act maliciously towards the data processing system. For additional details regarding measurements collection process 204, refer to FIG. 2D.

The measurements collected from the hardware components during measurements collection process 204 may be used to perform measurements provision to trusted platform module (TPM) process 206. During measurements provision to TPM process 206, the BIOS may provide the measurements to the TPM of the data processing system (e.g., TPM 120). TPM 120 may include (and/or may be included as part of) a secure hardware component (e.g., a chip) with physical security mechanisms that reduce a likelihood of malicious and/or erroneous software compromising the data processing system (e.g., by verifying the authenticity and/or integrity of software hosted by various hardware components). The measurements may be provided to TPM 120 following a set of specifications and/or standards such as the Trusted Computing Group PC Client Platform Firmware Profile (TCP PFP). TPM 120 (e.g., reports generated by TPM 120) may then be used to compute a security posture of the data processing system (e.g., in collaboration with startup manager 102). Based on the security posture determined, at least in part, using TPM 120, booting may be allowed to proceed, some functions of the data processing system may be limited, and/or other remedial actions may be performed should the security posture not meet certain requirements (e.g., activity facilitated by the TPM may be policy driven, with the policies being keyed to the security posture of the data processing system as calculated using the TPM). Refer to the description of FIG. 1 for additional details regarding TPM 120.

Once the measurements have been provided to TPM 120 (e.g., and presuming that the measurements indicate an acceptable security posture), operating system boot process 208 may be performed. During operating system boot process 208, program code for an operating system and/or other type of operational management entity (e.g., operation manager 104 shown in FIG. 1) may be loaded onto the processor and booted so that management of the operation of the data processing system may be handed off from the BIOS to the operating system. After the handoff, the BIOS may shut down, be placed in standby, etc. Management may be handed off to the operating system to place the data processing system into a predetermined manner of operation (e.g., a manner of operation that supports execution of applications). The operating system may, for example, provide abstracted access to resources utilized by the applications, manage data storage and data retrieval, and/or perform other actions that allow for the applications that provide (all or a portion of) the computer-implemented services to execute on the data processing system.

Booting the operating system may indicate a transition from pre-boot environment 200 to post-boot environment 210. Post-boot environment 210 may include operations performed (e.g., by a management entity of the data processing system such as the operating system) to manage operation of the data processing system based on a security posture of the data processing system (e.g., established using TPM 120).

Once the operating system is booted, host-based TPM verification process 212 may be performed (e.g., a host-based verification process may be performed using the TPM of the data processing system). During host-based TPM verification process 212, TPM 120 may perform tasks related to security management of the data processing system. To do so, measurements obtained from the BIOS may be used to perform security verification processes of the hardware and/or software components using TPM 120. For example, reports generated by TPM 120 may be used to verify the authenticity and/or integrity of untrusted data structures (e.g., the measurements) using trusted data structures, such as trusted hashes, and security programs such as a signature verification algorithm. The trusted data structures may be established during manufacturing of the data processing system and may be stored in TPM 120 and/or may be obtained by TPM 120 from trusted data sources (e.g., a unified extensible firmware (UEFI) signature database).

Host-based TPM verification process 212 may establish a security posture of the data processing system. The security posture may be based on a result of the security verification processes performed using TPM 120. For example, if, using reports generated by TPM 120, the authenticity and/or integrity of all and/or a portion of the hardware components is unable to be verified (e.g., the security posture includes indications of compromise), actions may be performed to reduce the likelihood of compromise of the data processing system. The actions may include limiting use of secrets managed by TPM 120 by the data processing system (e.g., the operating system) based on the security posture of the data processing system and/or performing other actions. The actions performed using TPM 120 may result in limited and/or reduced functionality of the operating system.

If at least one hardware component is unable to be verified using TPM 120 (e.g., using reports generated by TPM 120 trust is unable to be established in software hosted by the at least one hardware component), the measurements obtained from the at least one hardware component may be provided to a remote entity (e.g., a server and/or any other management system for the data processing system). The measurements collected from the at least one hardware component may be used to perform server TPM verification process 214. During server TPM verification process 214, the remote entity may perform tasks related to verifying the integrity and/or authenticity of the at least one hardware component. To do so, the remote entity may use a data structure including expected integrity measurements of the at least one hardware component’s software (e.g., a component refence integrity manifest). The remote entity may provide a response to the operating system indicating whether the at least one hardware component is verified.

To reduce the amount of time to complete booting of the data processing system, some devices (e.g., not necessary to boot the data processing system) may not be initialized until after operation of the data processing system is handed off to the operating system. To verify those devices, other measurements collection process 216 may be performed. During other measurements collection process 216, measurements usable to verify the authenticity and/or integrity of software hosted by the devices (e.g., other SPDM capable devices 218) may be obtained (e.g., by the operating system). The measurements may be obtained based on an SPDM security standard and other SPDM capable devices 218 may be compliant with the SPDM security standard.

To verify the measurements obtained from other SPDM capable devices 218, server devices verification process 220 may be performed. During server devices verification process 220, the measurements may be provided to a remote system (e.g., a server and/or other backend system) and used to perform the device verification processes remotely. To perform the device verification processes, the remote system may use trusted data structures stored in standards repository 222 to verify the untrusted data structures (e.g., the measurements). Standards repository 222 may include a database of trusted integrity measurements (e.g., a TCG component reference integrity manifest) which may be used to establish trust in the measurements from each device of other SPDM capable devices 218.

An outcome of any of the device verification processes performed by components of the data processing system and/or remote entities may be used to perform zero trust policy enforcement process 224. The outcome may include an indication of whether any of the hardware components are unable to be verified (e.g., whether trust in any of the hardware components is unable to be established). The outcome may also include an indication of a security state of the data processing system identified by comparing a copy of a local certificate trust store log to a remote certificate trust store log (e.g., maintained by a remote system such as a server).

During zero trust policy enforcement process 224 and based on the outcome, at least one action may be identified and performance of the at least one action may be initiated (e.g., by the operating system) to manage operation of the data processing system. For example, remedial actions may be performed if the outcome indicates a hardware component is unable to be verified and/or the data processing system is in a compromised security state. The remedial actions may be based on a predetermined zero trust policy that may reduce a likelihood of compromise and/or other undesired impacts on the data processing system. For example, the zero trust policy may include: (i) preventing the hardware component that is unable to be verified from booting, (ii) shutting down the data processing system, (iii) providing a notification to a user of the data processing system indicating the hardware component is unable to be verified and/or the data processing system is in the compromised security state, (iv) obtaining user input regarding any actions that are to be performed as a result of the hardware component being unable to be verified and/or the data processing system being in the compromised security state, and/or (v) other remedial actions.

As a result of performing zero trust policy enforcement process 224, result 226 may be obtained. Result 226 may include instructions for the operating system and/or any other management entity of the data processing system to perform various remedial actions based on the zero trust policy. Based on result 226, the operating system may manage operation of the data processing system.

Thus, by implementing the data flow shown in FIG. 2A, a system in accordance with embodiments disclosed herein may be used to manage operation of a data processing system in a manner that reduces a likelihood of the data processing system becoming compromised and/or operating in an undesired manner. Consequently, computer-implemented services provided using the data processing system may be provided as desired.

Turning to FIG. 2B, a second data flow diagram in accordance with an embodiment is shown. The second data flow diagram may illustrate data used in and data processing performed in cooperatively identifying a security state (e.g., security state 240) of a data processing system (e.g., similar to data processing system 100 shown in FIG. 1) by an entity of the data processing system and a remote system. The identified security state may be used as part of performing zero trust policy enforcement process 224 described in FIG. 2A.

To cooperatively identify security state 240, the entity of the data processing system may identify an occurrence of a security event for the data processing system which initiates the performance of certificate log copying process 232. The entity may include an operating system agent (e.g., similar to operation manager 104 shown in FIG. 1) and/or any other entity of the data processing system. The entity may identify the occurrence of the security event by obtaining security event alert 230.

Security event alert 230 may include any type of security trigger that indicates the occurrence of the security event to the entity. For example, the security event may include: (i) the data processing system entering an elevated security mode (e.g., if the data processing system is going to access sensitive databases and/or perform processes using sensitive data such as financial data, medical data, personal identifiable information, etc.), (ii) obtaining a request for data usable to cooperatively identify security state 240 (e.g., local certificate trust store log copy 234) and/or instructions to perform certificate log copying process 232 from the remote system and/or any other management entity of the data processing system, and/or (iii) other types of security events. The occurrence of the security event may result in security event alert 230 usable to identity the security event being obtained by the entity.

While described with respect to initiating the performance of certificate log copying process 232 by obtaining security event alert 230, it will be appreciated that the performance of certificate log copying process 232 may be initiated without obtaining security event alert 230 without departing from embodiments disclosed herein. For example, the entity may identify the occurrence of a security event based on a predefined schedule, and may then perform certificate log copying process 232. For example, identification of security state 240 for the data processing system may be scheduled to occur weekly, which may trigger the entity to perform certificate log copying process 232.

Upon obtaining security event alert 230 (and/or otherwise identifying the occurrence of the security event), the entity may perform certificate log copying process 232. During certificate log copying process 232, the entity may obtain a copy of a local certificate trust store log (e.g., local certificate trust store log copy 234). The local certificate trust store log may indicate modifications made to a local certificate trust store managed by the data processing system.

The local certificate trust store may include certificates (e.g., portions of certificate chains, digests of the portions of the certificate chains such as hashes and/or other representations of the portions of the certificate chains) for devices of the data processing system which may be cryptographically verifiable. The local certificate trust store may also include levels of trust for the certificates (e.g., trusted, untrusted). The certificates may include: (i) device certificates (e.g., leaf certificates), (ii) any number of intermediate certificates (e.g., certificates issued by intermediate certificate authorities that link the device certificates to root certificates), and/or (iii) root certificates (e.g., signed by root certificate authorities). For example, the local certificate trust store may include a list of trusted root certificates and a list of untrusted root certificates usable to establish trust in certificate chains by verifying the root certificates of the certificate chains are trusted by the data processing system.

The local certificate trust store may be usable to determine a level of trust in an SPDM security standard compliant device during a startup of the data processing system. To determine the level of trust, a certificate obtained from the device may be compared to the certificates in the local certificate trust store. Refer to the description of FIG. 2D for additional details regarding determining levels of trust in devices using the local certificate trust store.

The local certificate trust store may be modified by the entity of the data processing system based on instructions and/or other information obtained from the remote system. The remote system may manage a remote certificate trust store, and updates and/or other modifications made to the remote certificate trust store may be provided to the entity for integration into the local certificate trust store. For example, the remote system may add, remove, and/or replace a root certificate in the remote certificate trust store, and may provide instructions to the entity to make similar modifications to the local certificate trust store. Modifications made to the remote certificate trust store may be included in a remote certificate trust store log, and modifications made to the local certificate trust store may be included in a local certificate trust store log. The logs may include information regarding the modification, a date and/or time of the modification, etc.

For example, the remote system may add a first root certificate from a trusted vendor (e.g., the first root certificate may have a trusted level of trust) to the remote certificate trust store and may remove a second root certificate that expired from the remote certificate trust store. The modifications to the remote certificate trust store may be included in the remote certificate trust store log. Instructions for updating the local certificate trust store in a similar manner (e.g., adding the first root certificate and removing the second root certificate) may be provided to the entity of the data processing system. The modifications to the local certificate trust store may be included in the local certificate trust store log. In doing so, the local certificate trust store log may be a duplication of (e.g., may match) at least a portion of the remote certificate trust store log.

The remote system may be a source of truth for the data processing system. For example, the remote system may be managed by a manufacturer of the data processing system and/or other entity trusted by the data processing system to not act maliciously towards the data processing system. Thus, the remote system may act as an authoritative source of trusted data, and therefore the remote certificate trust store may be trusted by the data processing system to not be compromised by a malicious entity. As a result, the entity may trust the modifications obtained from the remote system for the local certificate trust store.

During certificate log copying process 232, the entity may copy at least a portion of the local certificate trust store log to obtain local certificate trust store log copy 234. Local certificate trust store log copy 234 may include: (i) a copy of the entire local certificate trust store log, (ii) a copy of a portion (e.g., sampling) of the local certificate trust store log (e.g., a copy of portions of the local certificate trust store log during a specified range of dates, a copy of portions of the local certificate trust store log added since a previous determination of a security state for the data processing system), (iii) a data structure derived from the local certificate trust store log such as a hash (e.g., obtained by applying a hash function to at least a portion of the local certificate trust store log), and/or (iv) other information regarding and/or obtained from the local certificate trust store log.

Local certificate trust store log copy 234 may then be used to perform security state identification process 236. During security state identification process 236, security state 240 may be collaboratively identified by the entity and the remote system based on local certificate trust store log copy 234. To do so, the entity may provide local certificate trust store log copy 234 to the remote system (e.g., via a message, by storing local certificate trust store log copy 234 in storage followed by retrieval of local certificate trust store log copy 234 by the remote system).

Local certificate trust store log copy 234 may be compared to remote certificate trust store log 238 to obtain an outcome. For example, the outcome may include: (i) a difference between local certificate trust store log copy 234 and remote certificate trust store log 238 (e.g., a list of portions of local certificate trust store log copy 234 and remote certificate trust store log 238 that do not match, a difference between a hash value of local certificate trust store log copy 234 and a hash value of at least a portion of remote certificate trust store log 238), (ii) a “yes” or “no” result indicating whether local certificate trust store log copy 234 matches (e.g., is a duplication of) at least a portion of remote certificate trust store log 238 (e.g., based on any criteria for matching), (iii) a value quantifying a degree of difference between local certificate trust store log copy 234 and remote certificate trust store log 238 (e.g., a percent difference), and/or (iv) any other outcome and/or quantity obtained as a result of the comparing.

Based on an outcome of comparing local certificate trust store log copy 234 and remote certificate trust store log 238, security state 240 may be obtained. Security state 240 may indicate the data processing system is in: (i) a secure security state (e.g., a likelihood that the local certificate trust store has been compromised is sufficiently low based on any criteria and/or threshold), (ii) a compromised security state (e.g., the likelihood that the local certificate trust store has been compromised is sufficiently high based on any criteria and/or threshold), and/or (iii) another security state. Security state 240 may be obtained by the entity from the remote system.

For example, security state 240 for the data processing system may indicate that the data processing system is in a secure security state when local certificate trust store log copy 234 is a duplication of at least a portion of remote certificate trust store log 238 (e.g., the local certificate trust store log matches at least a portion of the remote certificate trust store log). Local certificate trust store log copy 234 may not be duplicative of the entirety of remote certificate trust store log 238 (e.g., the remote certificate trust store may include certificates, digests, and/or other information for other types of devices than that of the data processing system and/or otherwise not stored in the local certificate trust store).

Security state 240 for the data processing system may indicate the data processing system is in a compromised security state when local certificate trust store log copy 234 has an unacceptable deviation from remote certificate trust store log 238. For example, local certificate trust store log copy 234 may have the unacceptable deviation when: (i) a difference between a hash of local certificate trust store log copy 234 and a hash of at least a portion of remote certificate trust store log 238 is nonzero, (ii) a precent difference between local certificate trust store log copy 234 and at least a portion of remote certificate trust store log 238 exceeds a threshold value (e.g., determined by the remote system, a subject matter expert, and/or another management entity of the data processing system), and/or (iii) other values for quantifying levels of deviation are determined to be unacceptable.

Returning to the above example, the remote certificate trust store log may indicate that: (i) the first root certificate was added to the remote certificate trust store, and (ii) the second root certificate was removed from the remote certificate trust store. The entity of the data processing system may provide a copy of the local certificate trust store log to the remote system, which may indicate that: (i) the first root certificate was added to the local certificate trust store, (ii) the second root certificate was removed from the local certificate trust store, and (iii) a third root certificate was added to the local certificate trust store. The remote certificate trust store log may be compared to the copy of the local certificate trust store log, and an outcome of the comparing may indicate that the local certificate trust store log has an unacceptable level of deviation from the remote certificate trust store log. Therefore, it may be identified that the data processing system is in a compromised security state (e.g., the local certificate trust store was potentially modified by a malicious/unauthorized entity).

Turning to FIG. 2C, a third data flow diagram in accordance with an embodiment is shown. The third data flow diagram may illustrate data used in and data processing performed in managing operation of the data processing system based on an identification that the data processing system is in a compromised security state (e.g., compromised security state 250). FIG. 2C may be an expansion of zero trust policy enforcement process 224 described in FIG. 2A.

If it is identified that the data processing system is in a compromised security state based on a copy of a local certificate trust store log, compromised security state 250 may be obtained. Compromised security state 250 may indicate that the copy of the local certificate trust store log has an unacceptable level of deviation from at least a portion of the remote certificate trust store log, which may indicate that the local certificate trust store was modified by an unauthorized and/or malicious entity.

Upon identifying compromised security state 250, action identification process 252 may be performed. During action identification process 252, at least one action (e.g., action 256) may be identified based on compromised security state 250 and policy 254. Policy 254 may include a policy, schema, and/or other type of rule set including actions keyed to security states of data processing systems. For example, policy 254 may be obtained from a management entity of the data processing system, such as a manufacturer of the data processing system, a user of the data processing system, a subject matter expert (SME), and/or any other entity that participates in managing operation of the data processing system.

Identifying action 256 during action identification process 252 may include performing a search using policy 254 and using compromised security state 250 as a key for the search. Action 256 may include one or multiple actions, which may include: (i) notifying a management entity of the data processing system (e.g., a user of the data processing system, a manufacturer of the data processing system), (ii) quarantining at least a portion of devices operably connected to the data processing system, (iii) monitoring the at least the portion of devices operably connected to the data processing system for indications of malicious activity, (iv) preventing the data processing system from performing at least a portion of its functionality until the data processing system is in a secure security state, and/or (v) other actions.

Upon obtaining action 256, performance of action 256 may be initiated. For example, performance of action 256 may be initiated by the entity (e.g., an operating system agent). As a result of initiating performance of action 256, a likelihood of the data processing system being compromised may be reduced.

For example, compromised security state 250 may be obtained if the local certificate trust store log and the remote certificate trust store log indicates that a root certificate was added to the local certificate trust store that was not added to the remote certificate trust store. The root certificate may have been added to the local certificate trust store by a malicious entity, and may allow a malicious device (e.g., controlled by the malicious entity) to be recognized by a startup manager of the data processing system as trusted. The malicious device may then be booted during startup of the data processing system. Once booted, the malicious device may access data stored on the data processing system, may install malicious software on the data processing system, etc. resulting in the data processing system being compromised. To reduce a likelihood of the data processing system being compromised, for example, a portion of the devices of the data processing system may be quarantined until the data processing system is in a secure security state. In doing so, potentially malicious devices may be prevented from booting and may be unable to compromise the data processing system.

Turning to FIG. 2D, a fourth data flow diagram in accordance with an embodiment is shown. The fourth data flow diagram may illustrate data used in and data processing performed in managing operation of the data processing system based on an identification that the data processing system is in a secure security state (e.g., secure security state 260). FIG. 2D may be an expansion of zero trust policy enforcement process 224 described in FIG. 2A.

If it is identified that the data processing system is in a secure security state based on a copy of a local certificate trust store log, secure security state 260 may be obtained. Secure security state 260 may indicate that the local certificate trust store log is a duplication of at least a portion of the remote certificate trust store log.

Upon identifying secure security state 260, at least one action may be identified based on secure security state 260 and a policy including actions keyed to security states of data processing systems. For example, based on secure security state 260 and the policy, the at least one action may include allowing a startup manager of the data processing system (and/or any other entity of the data processing system, such as the operating system) to boot devices during a startup of the data processing system. Refer to the description of FIG. 2C for additional details regarding identifying the at least one action.

Allowing the startup manager to boot devices may include performing certificate analysis process 262 for the devices during the startup. During certificate analysis process 262, a certificate (e.g., at least a portion of a certificate chain and/or a digest of the at least the portion of the certificate chain, not shown) may be obtained from a device of the data processing system using an SPDM security standard (e.g., via an SPDM message exchange between the startup manager and the device).

Using the certificate and local certificate trust store 264, an analysis process may be performed to identify a level of trust in the device. Local certificate trust store 264 may be a part of reference values data 118 described in FIG. 1, and may include certificates (e.g., at least portions of certificate chains and/or digests of the at least the portions of the certificate chains obtained by applying any number and type of algorithms to the at least the portions of the certificate chains) for devices and classifications for the certificates corresponding to levels of trust.

For example, the certificates included in local certificate trust store 264 may be classified as: (i) known good (e.g., having a trusted level of trust), (ii) known bad (e.g., having an untrusted level of trust), and/or (iii) other classifications. For example, known good certificates may be included in local certificate trust store 264 for devices produced by a manufacturer of the data processing system (e.g., and therefore the devices may be trusted to not act maliciously towards the data processing system). Known bad certificates, for example, may include certificates for potentially malicious devices, devices with identified security issues, and/or otherwise unsupported devices (e.g., and therefore the devices may not be trusted to not act maliciously towards the data processing system).

To determine the level of trust in the device during certificate analysis process 262, the certificate obtained from the device may be compared to certificates included in local certificate trust store 264. For example, the startup manager may perform a search in local certificate trust store 264 using at least a portion of the certificate obtained from the device as a key for the search. Based on the search, the startup manager may identify whether the certificate obtained from the device corresponds to a known good and/or known bad certificate included in local certificate trust store 264. Based on the identification, the level of trust in the device may be determined.

As a result of performing certificate analysis process 262, an outcome may be obtained. The outcome may indicate a level of trust in the device, which may include: (i) a trusted level of trust (e.g., trusted level of trust 266), (ii) an untrusted level of trust, and/or (iii) an indeterminate level of trust. Trusted level of trust 266 may be obtained if the certificate obtained from the device matches a known good certificate included in local certificate trust store 264. For example, the certificate may match a known good certificate when a difference between the certificate and the known good certificate is zero.

Similarly, an untrusted level of trust may be obtained if the certificate obtained from the device matches a known bad certificate included in local certificate trust store 264 (e.g., a difference between the certificate and a known bad certificate is zero).

An indeterminate level of trust may be obtained if the certificate obtained from the device does not match a certificate included in local certificate trust store 264. For example, an indeterminate level of trust may be obtained for the device if a difference between the certificate and certificates included in local certificate trust store 264 is nonzero.

If trusted level of trust 266 is obtained, the startup manager may perform device measurements collection process 268. During device measurements collection process 268, a measurement process may be performed using the SPDM security standard (e.g., via an SPDM message exchange) for the device to obtain at least one measurement (e.g., device measurements 270). Device measurements 270 may include security data (e.g., hashes of software code hosted by the device) usable to validate authenticity and/or integrity of software hosted by the device. Refer to the description of FIG. 2A for additional details regarding obtaining measurements from devices using the SPDM security standard.

Using device measurements 270, measurement verification process 272 may be performed. During measurement verification process 272, device measurements 270 may be analyzed to verify the integrity and/or authenticity of the software hosted by the device. To do so, trusted measurements 274 and a TPM of the data processing system (e.g., similar to TPM 120 described in FIG. 1 and FIG. 2A) may be used. Trusted measurements 274 may be a part of reference values data 118 shown in FIG. 1, and may include data structures trusted by the TPM and usable to verify device measurements 270.

For example, device measurements 270 may be used to verify the authenticity and/or integrity of the software hosted by the device by comparing device measurements 270 to trusted (e.g., known good) measurements included as part of trusted measurements 274. Trusted measurements 274 may be stored in the TPM and/or may be provided to (e.g., loaded into) the TPM from trusted data sources. Refer to the description of FIG. 1 and FIG. 2A for additional details regarding the TPM and reference values data 118.

A result of performing measurement verification process 272 may be obtained, which may include: (i) verified measurements 276, and/or (ii) unverified measurements 278. Obtaining verified measurements 276 for the device may indicate that device measurements 270 are trusted measurements, which may indicate that the authenticity and/or integrity of the software hosted by the device was verified. Obtaining unverified measurements 278 for the device may indicate that device measurements 270 are not trusted measurements, which may indicate that the authenticity and/or integrity of the software hosted by the device was unable to be verified (e.g., the device may be untrusted and/or a level of trust in the device may be indeterminate).

Based on the result, operation of the device may be managed (e.g., based on a policy and/or other rule set for managing operation of devices). For example, if verified measurements 276 is obtained for the device (e.g., the at least one measurement is able to be verified as trusted), at least a portion of the functionality of the device may be enabled (e.g., the device may be allowed to perform at least a portion of its functions and/or interact with the data processing system as requested by the device).

If unverified measurements 278 is obtained for the device (e.g., the at least one measurement is not able to be verified as trusted): (i) the device may be prevented from performing at least a portion of its functionality (e.g., the device may be restricted from performing functions and/or interactions between the device and the data processing system may be limited), (ii) information regarding trustworthiness of the device may be logged (e.g., an identifier for the device and/or other information obtained from the device and/or as a result of performing measurement verification process 272 may be added to a log maintained by the BIOS, operating system, and/or any other entity), (iii) the device may be quarantined (e.g., until the device can be verified via other methods), (iv) activity of the device may be screened for indications of malicious behavior, and/or (v) other actions may be performed reduce a likelihood of the data processing system being compromised by the device.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1-2D may perform various methods to manage data used to provide computer-implemented services. FIG. 3 illustrates a method that may be performed by the components of the system of FIGS. 1-2D. In the diagrams discussed below and shown in FIG. 3, any of the operations may be repeated, performed in different orders, and/or performed in parallel with or in a partially overlapping in time manner with other operations.

Turning to FIG. 3, a flow diagram illustrating a method for managing operation of a data processing system in accordance with an embodiment is shown. The method may be performed, for example, by any of the components of the system of FIG. 1, and/or any other entity without departing from embodiments disclosed herein.

At operation 300, an entity of the data processing system may identify an occurrence of a security event for the data processing system. Identifying the occurrence of the security event may include: (i) obtaining a security event alert indicating the occurrence of the security event, (ii) receiving a message from another entity (e.g., a remote system) indicating the occurrence of the security event (e.g., the message may include a request for information from the entity), (iii) identifying the occurrence of the security event based on a schedule (e.g., the security event may be scheduled to occur at a specific time and/or over predetermined increments of time), (iv) identifying the occurrence of the security event based on actions that are to be performed by the data processing system (e.g., if the data processing system is going to access and/or use sensitive data), and/or (v) other methods.

At operation 302, the entity may obtain a copy of a local certificate trust store log, the local certificate trust store log indicating modifications made to a local certificate trust store managed by the data processing system. Obtaining the copy of the local certificate trust store log may include: (i) generating the copy of the local certificate trust store log, (ii) reading the copy of the local certificate trust store log from storage, (iii) receiving the copy of the local certificate trust store log from another entity, and/or (iv) other methods.

Generating the copy of the local certificate trust store log may include: (i) generating a data structure including a duplication of the entire local certificate trust store log, (ii) generating a data structure including a duplication of a portion of the local certificate trust store log, (iii) obtaining a hash and/or other representation of at least a portion of the local certificate trust store log (e.g., by applying any number and type of functions to the at least the portion of the local certificate trust store log), and/or (iv) other methods.

At operation 304, the entity and a remote system may cooperatively identify a security state of the data processing system based on the copy of the local certificate trust store log. Cooperatively identifying the security state may include: (i) providing, by the entity, the copy of the local certificate trust store log to the remote system, (ii) obtaining, by the entity, the security state of the data processing system from the remote system, the security state of the data processing system being based on an outcome of comparing the copy of the local certificate trust store log to a remote certificate trust store log managed by the remote system, and/or (iii) other methods.

Providing the copy of the local certificate trust store log to the remote system may include: (i) transmitting the copy of the local certificate trust store log to the remote system via a message, (ii) storing the copy of the local certificate trust store log in storage with subsequent retrieval by the remote system, (iii) a publish-subscribe system where the remote system subscribes to updates from the entity thereby causing the copy of the local certificate trust store log to be propagated to the remote system, and/or (iv) other methods.

Obtaining the security state of the data processing system may include: (i) receiving the security state via a message from the remote system, (ii) reading the security state from a storage used by the remote system, and/or (iii) other methods.

Cooperatively identifying the security state may also include: (i) receiving, by the entity, a copy of the remote certificate trust store log, (ii) comparing, by the entity, the remote certificate trust store log to the copy of the local certificate trust store log to obtain an outcome, (iii) identifying the security state based on the outcome, and/or (iv) other methods.

For example, if the outcome indicates that the local certificate trust store log is sufficiently similar to the remote certificate trust store log (e.g., based on any criteria and/or threshold), it may be identified that the data processing system is in a secure security state. If the outcome indicates that the local certificate trust store log is sufficiently different from the remote certificate trust store log (e.g., based on any criteria and/or threshold), it may be identified that the data processing system is in a compromised security state.

At operation 306, operation of the data processing system may be managed based on the security state to reduce a likelihood of the data processing system being compromised. Managing operation of the data processing system may include: (i) identifying, based on the security state of the data processing system and a policy including actions keyed to security states of data processing systems, at least one action, (ii) initiating performance of the at least one action, and/or (iii) other methods.

Identifying the at least one action may include: (i) obtaining the policy (e.g., including a rule set, schema, and/or any other data structure) usable to determine the at least one action based on the security state of the data processing system (e.g., reading the policy from storage, receiving the policy from another entity, generating the policy), (ii) performing a search using the policy and at least the security state of the data processing system as a key for the search to identify the at least one action, (iii) receiving the at least one action from another entity (e.g., the remote system), and/or (iv) other methods.

Initiating performance of the at least one action may include: (i) performing the at least one action (e.g., by the entity, which may include an operating system agent), (ii) providing instructions to another entity and/or component of the data processing system to perform the at least one action, and/or (iii) other methods.

For example, if it is identified that the data processing system is in a compromised security state, initiating performance of the at least one action may include: (i) notifying a management entity of the data processing system that the data processing system is in a compromised security state (e.g., transmitting the notification via a message to the management entity, storing the notification in storage with subsequent retrieval by the management entity), (ii) quarantining at least a portion of devices operably connected to the data processing system (e.g., isolating the at least a portion of devices until the data processing system is in a secure security state), (iii) monitoring the at least the portion of devices operably connected to the data processing system for indications of malicious activity (e.g., screening activity of the at least the portion of devices for malicious behavior), (iv) preventing the data processing system from performing at least a portion of its functionality until the data processing system is in a secure security state (e.g., preventing the data processing system from booting, restricting access by the data processing system to sensitive data and/or databases, restricting communication capabilities of the data processing system), and/or (v) other methods.

If it is identified that the data processing system is in a secure security state, initiating performance of the at least one action may include, during a startup of the data processing system, (i) performing, using a certificate obtained from a device of the data processing system using an SPDM security standard and the local certificate trust store, an analysis process to identify a level of trust in the device, (ii) in an instance of the performing in which the level of trust in the device is trusted: performing a measurement process using the SPDM security standard for the device to obtain at least one measurement, (iii) managing operation of the device based on the at least one measurement, and/or (iv) other methods. Initiating performance of the at least one action if the data processing system is in a secure security state may also include allowing the data processing system to perform at least a portion of its functionality (e.g., permitting the data processing system to boot, allowing access by the data processing system to sensitive data and/or databases).

Performing the analysis process may include: (i) obtaining a certificate (e.g., at least a portion of a certificate chain and/or a data structure representing the at least the portion of the certificate chain such as a digest) for a device of the data processing system using an SPDM security standard (e.g., providing, by the entity and via an SPDM message exchange with the device, a request for the certificate to the device and receiving the certificate in response, reading the certificate from storage, receiving the certificate from another entity), (ii) identifying, based on the certificate and certificates in the local certificate trust store, the level of trust in the device, (iii) receiving the level of trust from another entity responsible for performing the analysis process, and/or (iv) other methods.

If the certificate includes a digest of at least a portion of the certificate chain, obtaining the digest may include: (i) requesting the digest from the device and receiving the digest in response, (ii) applying a predetermined function to the certificate to obtain the digest, (iii) receiving the digest from another entity, (iv) reading the digest from storage, and/or (v) other methods.

Applying the predetermined function to the certificate to obtain the digest may include: (i) using the certificate as input to an algorithm, such as a hash function and/or any other type and/or quantity of functions, (ii) obtaining, as output from the algorithm, the digest, (iii) providing, by the entity, the certificate and/or instructions for applying the predetermined function to the certificate to another entity and receiving the digest in response, and/or (iv) other methods.

Identifying the level of trust in the device based on the certificate and the certificates in the local certificate trust store may include: (i) comparing the certificate to the certificates included in the local certificate trust store, (ii) obtaining a result of the comparing, the result indicating whether the certificate matches (and/or otherwise agrees with) a certificate included in the local certificate trust store (e.g., reading the result, receiving the result from another entity), (iii) identifying, based on the result, the level of trust in the device, and/or (iv) other methods.

Comparing the certificate to certificates included in the local certificate trust store may include: (i) performing a matching process to determine whether the certificate matches any certificates included in the local certificate trust store, (ii) performing any other comparison process to determine whether the certificate agrees with a certificate included in the local certificate trust store, (iii) providing the certificate to another entity (e.g., an entity with access to and/or that is responsible for managing the local certificate trust store) responsible for comparing the certificate to certificates included in the local certificate trust store, and/or (iv) other methods.

Identifying the level of trust in the device may include: (i) determining which classification of certificate the certificate matches (and/or otherwise agrees with), the classification including a known good certificate and/or a known bad certificate, (ii) assigning the level of trust to the certificate based on the classification, and/or (iii) other methods. In a first example, if the certificate matches a known good certificate, the level of trust may be trusted. In a second example, if the certificate matches a known bad certificate, the level of trust may be untrusted. If the certificate does not match a known good certificate and/or a known bad certificate, the level of trust may be identified as indeterminate.

If the level of trust in the device is trusted, the measurement process may be performed using the SPDM security standard for the device to obtain the at least one measurement. Performing the measurement process may include: (i) obtaining the at least one measurement from the device, (ii) analyzing the at least one measurement to determine whether the at least one measurement is a trusted measurement, and/or (iii) other methods.

Obtaining the at least one measurement may include: (i) performing an SPDM message exchange (e.g., initiated by the data processing system) with the device to obtain the at least one measurement, (ii) requesting the at least one measurement from another entity (e.g., an intermediate entity) and receiving the at least one measurement in response, (iii) reading the at least one measurement from storage, and/or (iv) other methods.

Analyzing the at least one measurement to determine whether the at least one measurement is a trusted measurement may include: (i) obtaining trusted data structures (e.g., stored in a TPM of the data processing system, from data sources trusted by the TPM such as a UEFI signature database), (ii) comparing the at least one measurement to the trusted data structures to obtain a result indicating whether the at least one measurement is the trusted measurement, (iii) providing the at least one measurement to another entity (e.g., a remote entity such as a server) and receiving a response indicating whether the at least one measurement is the trusted measurement, and/or (iv) other methods.

For example, the at least one measurement may include a hash value of a portion of software hosted by the device generated using a predetermined hash function. Analyzing the at least one measurement may include comparing the hash value to a known good hash value trusted by the TPM (e.g., a trusted data structure) in order to obtain a difference. The difference may be zero (e.g., when the hash values match) or nonzero (e.g., when the hash values do not match). If the difference is zero, for example, then the result may indicate that the at least one measurement is the trusted measurement. Otherwise, if the difference is nonzero, then the result may indicate that the at least one measurement is not the trusted measurement.

Managing operation of the device based on the at least one measurement may include: (i) permitting the device to boot, (ii) allowing the device to communicate with the data processing system, (iii) allowing the device to access data stored on the data processing system, (iv) logging information regarding the trustworthiness of the device, (v) preventing the device from performing at least a portion of its functionality, and/or (vi) other methods.

If the level of trust in the device is untrusted, the device may be prevented from performing at least a portion of its functionality, and/or information regarding trustworthiness of the device may be logged. Preventing the device from performing at least a portion of its functionality and/or logging information regarding trustworthiness of the device may include: (i) preventing the device from booting, (ii) restricting access by the device to data stored on the data processing system, (iii) restricting an ability of the device to communicate with the data processing system, (iv) generating an entry in a log indicating that the level of trust for the device is untrusted, and/or (v) other methods.

The method may end following operation 306.

Thus, as illustrated above, embodiments disclosed herein may provide systems and methods to facilitate startups of a data processing system in a manner that improves security during startup. By comparing a copy of a local certificate trust store log and a remote certificate trust store log, a security state of the data processing system may be identified. The security state may be usable to manage operation of the data processing system. In doing so, the security of the data processing system may be improved.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows^{®} operating system from Microsoft^{®}, Mac OS^{®}/iOS^{®} from Apple, Android^{®} from Google^{®}, Linux^{®}, Unix^{®}, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
identifying, by an entity of the data processing system, an occurrence of a security event for the data processing system;
obtaining, by the entity, a copy of a local certificate trust store log, the local certificate trust store log indicating modifications made to a local certificate trust store managed by the data processing system;
cooperatively identifying, by the entity and a remote system, a security state of the data processing system based on the copy of the local certificate trust store log; and
managing operation of the data processing system based on the security state to reduce a likelihood of the data processing system being compromised.

2. The method of claim 1, wherein cooperatively identifying the security state of the data processing system comprises:
providing, by the entity, the copy of the local certificate trust store log to the remote system; and
obtaining, by the entity, the security state of the data processing system from the remote system, the security state of the data processing system being based on an outcome of comparing the copy of the local certificate trust store log to a remote certificate trust store log managed by the remote system.

3. The method of claim 2, wherein the remote certificate trust store log indicates modifications made to a remote certificate trust store managed by the remote system.

4. The method of claim 3, wherein the remote system is a source of truth for the data processing system, and the remote certificate trust store is trusted by the data processing system to not be compromised by a malicious entity.

5. The method of claim 4, wherein the data processing system is in a secure security state when the local certificate trust store log is a duplication of at least a portion of the remote certificate trust store log.

6. The method of claim 1, wherein managing operation of the data processing system comprises:
identifying, based on the security state of the data processing system and a policy comprising actions keyed to security states of data processing systems, at least one action; and
initiating performance of the at least one action.

7. The method of claim 6, wherein in an instance of the cooperatively identifying in which the data processing system is in a compromised security state, the at least one action to manage operation of the data processing system comprises at least one action selected from a list of actions consisting of:
notifying a management entity of the data processing system;
quarantining at least a portion of devices operably connected to the data processing system;
monitoring the at least the portion of devices operably connected to the data processing system for indications of malicious activity; and
preventing the data processing system from performing at least a portion of its functionality until the data processing system is in a secure security state.

8. The method of claim 1, wherein the local certificate trust store comprises certificates and/or digests of certificates usable to determine a level of trust in a security protocol and data model (SPDM) security standard compliant device during a startup of the data processing system.

9. The method of claim 8, wherein the level of trust in the SPDM security standard compliant device is determined by comparing a certificate obtained from the device to the certificates in the local certificate trust store.

10. The method of claim 1, wherein the entity of the data processing system is an operating system agent.

11. The method of claim 1, further comprising:
in an instance of the cooperatively identifying in which the data processing system is in a secure security state:
during a startup of the data processing system:
performing, using a certificate obtained from a device of the data processing system using an SPDM security standard and the local certificate trust store, an analysis process to identify a level of trust in the device;
in an instance of the performing in which the level of trust in the device is trusted:
performing a measurement process using the SPDM security standard for the device to obtain at least one measurement; and
managing operation of the device based on the at least one measurement.

12. A non-transitory machine-readable medium having instructions stored therein, which when executed by a processor, cause the processor to perform operations for managing operation of a data processing system, the operations comprising:
identifying, by an entity of the data processing system, an occurrence of a security event for the data processing system;
obtaining, by the entity, a copy of a local certificate trust store log, the local certificate trust store log indicating modifications made to a local certificate trust store managed by the data processing system;
cooperatively identifying, by the entity and a remote system, a security state of the data processing system based on the copy of the local certificate trust store log; and
managing operation of the data processing system based on the security state to reduce a likelihood of the data processing system being compromised.

13. The non-transitory machine-readable medium of claim 12, wherein cooperatively identifying the security state of the data processing system comprises:
providing, by the entity, the copy of the local certificate trust store log to the remote system; and
obtaining, by the entity, the security state of the data processing system from the remote system, the security state of the data processing system being based on an outcome of comparing the copy of the local certificate trust store log to a remote certificate trust store log managed by the remote system.

14. The non-transitory machine-readable medium of claim 13, wherein the remote certificate trust store log indicates modifications made to a remote certificate trust store managed by the remote system.

15. The non-transitory machine-readable medium of claim 14, wherein the remote system is a source of truth for the data processing system, and the remote certificate trust store is trusted by the data processing system to not be compromised by a malicious entity.

16. The non-transitory machine-readable medium of claim 15, wherein the data processing system is in a secure security state when the local certificate trust store log is a duplication of at least a portion of the remote certificate trust store log.

17. A data processing system, comprising:
a processor; and
a memory coupled to the processor to store instructions, which when executed by the processor, cause the processor to perform operations for managing operation of a data processing system, the operations comprising:
identifying, by an entity of the data processing system, an occurrence of a security event for the data processing system;
obtaining, by the entity, a copy of a local certificate trust store log, the local certificate trust store log indicating modifications made to a local certificate trust store managed by the data processing system;
cooperatively identifying, by the entity and a remote system, a security state of the data processing system based on the copy of the local certificate trust store log; and
managing operation of the data processing system based on the security state to reduce a likelihood of the data processing system being compromised.

18. The data processing system of claim 17, wherein cooperatively identifying the security state of the data processing system comprises:
providing, by the entity, the copy of the local certificate trust store log to the remote system; and
obtaining, by the entity, the security state of the data processing system from the remote system, the security state of the data processing system being based on an outcome of comparing the copy of the local certificate trust store log to a remote certificate trust store log managed by the remote system.

19. The data processing system of claim 18, wherein the remote certificate trust store log indicates modifications made to a remote certificate trust store managed by the remote system.

20. The data processing system of claim 19, wherein the remote system is a source of truth for the data processing system, and the remote certificate trust store is trusted by the data processing system to not be compromised by a malicious entity.
